(19) United States
(12) Patent Application Publication
(10) Pub. No.: US 2003/0033585 A1
(43) Pub. Date: Feb. 13, 2003

(54) Time management system

(76) Inventor: Catherine Elizabeth Korfanty Sheets, Tallahassee, FL (US)

Correspondence Address: Carnes, Cona & Dixon, Innovation Park, 1673 West Paul Dirac Drive, Tallahassee, FL, 32310-3763, US

(21) Appl. No.: 09/925,877

(22) Filed: Aug. 9, 2001

(51) Int. Cl. G06F 9/44

(52) U.S. Cl. 717/100

(57) ABSTRACT

The present invention is a universal interactive time management system that is designed and configured to efficiently and adequately manage, record, organize, store, remind, and/or execute particular data and/or instructions, as deemed and programmed necessary by the user. The system of the present invention is further designed to be capable of interfacing and integrating with other existing devices, such as mobile platform devices (i.e. Palm Pilot™) and/or networks (i.e. eCal™ or My Palm™). Having the capability of interfacing will consequently enhance its functionality and provides a real-time means of time management activity. As a result providing a system that constantly updates and maintains the user's schedule, agenda and pertinent data information. In essence providing a system that is designed to identify and track specific time management related information and reminds the user of important dates, appointments and/or schedules. This system is easy to initiate because it prompts the user with questions in order to acquire the necessary data.

### BACKGROUND OF THE INVENTION

1. Field of the Invention

The present invention relates generally to a novel and unique universal interactive time management system and more particularly to a universal interactive system that will successfully and efficiently record, update, remind and execute proper data and/or instructions for providing a system that acts as a personal assistant for ultimately reducing stress and increase time proficiency for the user. The present invention further provides for a system that includes various sub-stations that can be personalized for the particular user, so as to provide for a time management system that can adequately categorize and organize any user's management situation, such as on a personal, business, and/or family level.

2. Description of the Prior Art

The need for constant organization continues to increase as people take on more and more activities that inherently lead to busier lives. As such there is a continuous desire to provide for products that are geared towards organizing and recording the appointments and agenda for one's hectic and busy life. These devices can be as simple as a daily journal that enables the user write in the particular time management criteria or can be as complex as a computer code that will record, categorize and organize each and data entry as entered by the user.

For example, in U.S. Pat. No. 6,026,410 issued to Allen et al there is disclosed a natural language based information organization and collaboration tool for a computer system with a method and apparatus for time and action/project management relating to the accessing and organizing information stored in a computer. This system allows for collaboration between two or more users.

Other data organizational device is disclosed in U.S. Pat. No. 5,588,141 issued to Smith et al. In this patent there is disclosed a pen-based computer system with unified data structure operations for performing computational services.

Yet another example of a time management device can be seen in U.S. Pat. No. 6,018,343 issued to Wang et al wherein disclosed is a Web-based calendar with links to calendar applets which are supported by an enhanced Java GUI foundation library. This Web-based calendar tool is related to the scheduling of appointments and daily events, with particular emphasis on separate coordination of schedules for a group of users.

Though these devices can be successful at organizing data, they tend to be limiting on its use and can be difficult to operate successfully, especially for those not comfortable utilizing electronic equipment, such as a personal computer. Accordingly, it is seen that there is a need for a universal time management system that can adequately and efficiently manage one's schedule as well as provide for a system that is easy to use and manipulate and prompts users with questions. This will provide a system that is user friendly and one that will entice and assist the particular individual utilizing the particular system.

As will be seen, the present invention addresses the needs as identified above by providing a system that substantially differs from prior data managing systems. Previous efforts do not provide the benefits intended with the present invention, such as providing a universal interactive time management system that personalizes and categorizes the particular user's agenda/data and prompts the user with questions so as to innately reduce stress and increase time efficiency.

The present invention achieves its intended purposes, objectives and advantages over the prior art devices by accomplishing the needs and objectives as identified herein, through a new, useful and unobvious combination of component elements, which is simple to use, with the utilization of a minimum number of functioning parts, at a reasonable cost to manufacture, assemble, test and by employing only readily available materials.

### SUMMARY OF THE INVENTION

The present invention is a universal interactive time management system that is designed and configured to efficiently and adequately manage, record, organize, store, remind, and/or execute particular data and/or instructions, as deemed and programmed necessary by the user. The system of the present invention is further designed to be capable of interfacing and integrating with other existing devices, such as mobile platform devices (i.e. Palm Pilot™) and/or networks (i.e. eCal™ or My Palm™). Having the capability of interfacing will consequently enhance its functionality and provides a real-time means of time management activity. As a result providing a system that constantly updates and maintains the user's schedule, agenda and pertinent data information. In essence providing a system that is designed to identify and track specific time management related information and reminds the user of important dates, appointments and/or schedules. This system is easy to initiate because it prompts the user with questions in order to acquire the necessary data.

Providing successful usability requires the use of five separate entities. The five entities being the user; the controlling system, the journal; the personal digital assistant (PDA); and the external digital assistant (EDA). The user, of course being the operator of the present invention. Thereby providing for the present invention to comprise of four sub-stations, known as the controlling station, the journal, the personal digital assistant station, and the external digital system station.

Each sub-system or substation is a separate entity. The entities can work independently or can be coupled to one another to adequately and efficiently store, organize, update, analyze and/or execute data and/or instructions as deemed necessary by the user.

The first sub-system, known as the controlling station, controls the subsequent stations and manipulates all entered and stored data. This controlling station is a computer code that is utilized for managing data. This journal includes a data bank system. The data bank system is divided into various sub-categories known as modules. These categories are determined by the user and thus provide for a system that is customized to the particular user's needs and desires. Examples of the various modules include, but are not limited to professional data, family data, health data, home data, automotive data, and the like. As the data is entered, the controlling station of the present invention will be programmed to request additional information so as to adequately an efficiently store the pertinent information. For example when entering the information in regards to an appointment, such as a physical examination, the present invention will ask the user if this is a regular appointment (exam). If the user answers yes, then the system of the present invention will continue to prompt questions, such as should this appointment be schedule in the future. Thereby, providing a means to record the data and automatically remind the user each subsequent appointment that is to schedule.

Coupled to the controlling station of the present invention is the journal or default scheduling application sub-station. This journal station is a default scheduling application operated on a personal computer platform and serves as the default repository for the archival data storage. Conventional programs, such as Microsoft Outlook™ or Lotus Organizer™, have been utilized to produce favorable results. However, it is to be expressly understood that the present invention could utilize other journal or default scheduling application systems.

Enhancing the present invention, additional substations can be added for increasing it versatility and usability. One substation that can be coupled to the controlling station includes the personal digital assistant station (PDA). At this substation, the controlling station will retrieve data from any conventional personal digital assistant device, such as Palm Pilot™. This data is transferred to the journal via conventional means and stored in the appropriate module.

External Digital Assistant (EDA) devices, such as eCal™ or My Palm™ can also be coupled to the controlling station. Enabling this coupling is the external digital assistant sub-station, which will retrieve data from these conventional devices and transferred the data to the respective data module. Retrieval of data occurs via conventional means.

In use, the system of the present invention will be designed and structured to be universal so as to provide for the present invention to be configured to operate on a variety of computing platforms. In addition, the system of the present invention is specifically designed to aid and assist the user by enabling the user to command and program the system to function and operate on any desired time frame. This will provide for the user to control when to be appraised of events, schedules, appointments or the like on either an hourly, daily, weekly, and/or monthly time frame. Due to its ability to collect, store and analyze individualized time management data, the present invention will be adapted to alert the user of any important subsequent information, so as to eliminate the need for the user to repeatedly enter the certain data, such as weekly scheduled office meetings, annual doctor appointments, or the like.

The present system has been specifically developed for users concerned with problems, which they presently encounter within the home and office environments in attempting to better structure, the use of their time. In addition, the present invention is designed to be a user-friendly system, so as to enable those with limited computer background to successfully operate and execute the system of the present invention. Thus, providing a system that will provide prompts so as to enable the user to answer the prompts for adequate storage of data.

Accordingly, it is the object of the present invention to provide for a universal interactive system for time management and other related procedures and which will overcome the deficiencies, shortcomings and drawbacks of prior systems and methods thereof.

Another object of the present invention is to provide for a universal interactive system for time management that can easily be utilized with any existing and conventional personal computer, digital assistant (PDA) devices, cellular phones, and the like.

Yet another object of the present invention is to provide access to essential time management programs without the need to reference additional sources such as the Worldwide Web.

A further object of the present invention is to save costly time and resources by providing constant instantaneous access to an efficient and reliable time management system.

Another object of the present invention is to compile a system including databases that have the capability of providing a direct source of time management information data for daily, weekly, monthly and yearly needs, as desired by the user.

Still a further object of the present invention to be specifically enumerated herein, is to provide for an interactive universal system for time management and other related procedures in accordance with the preceding objects and which will conform to conventional forms, be of simple design and easy to use so as to provide a system that will be economically feasible, long lasting and relatively trouble free in operation.

Although there have been inventions related to time management procedures none of these inventions provide the benefits associated with the present invention. The present invention meets the requirements of providing for a simplified design with low initial cost, low operating cost, ease of installation and maintainability with a minimum amount of training to successfully employ the invention.

The foregoing has outlined some of the more pertinent objects of the present invention. These objects should be construed to be merely illustrative of some of the more prominent features and applications of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWINGS

FIG. 1 is a block diagram, which depicts the time management system of the present invention.

FIG. 2 is a conceptual flow diagram of the structure of the time management system of the present invention.

FIG. 3 is a detail conceptual flow diagram of the structure of the time management system of the present invention.

FIG. 4a through FIG. 4c are examples of questions and/or prompt that are used for Family and Friends Module of the time management system of the present invention.

FIG. 5a through FIG. 5c are examples of questions and/or prompt that are used for the Health and Nutrition Module of the time management system of the present invention.

FIG. 6 is an example of questions and/or prompts that are used for the Home and Yard Maintenance Module of the time management system of the present invention.

FIG. 7 is an example of questions and/or prompts that are used for the Vehicle Planning Module of the time management system of the present invention.

FIG. 8 is an example of questions and/or prompts that are used for the Entertainment/Recreation/Vacation Module of the time management system of the present invention.

FIGS. 9a through 9b are an example of questions and/or prompts that are used for the Business/Professional Module of the time management system of the present invention.

FIG. 10 is an example of questions and/or prompts that are used for the Education/Sports/Extra-curricular Activities of the time management system of the present invention.

FIG. 11 is an example of the initiating window/prompt used to initiate the of the time management system of the present invention.

FIG. 12 is an example of the initial menu window used for guiding the user to the appropriate area of the of the time management system of the present invention.

FIG. 13 is an example of the retrieval daily calendar prompt used to retrieve the daily calendar of the time management system of the present invention.

FIG. 14 is an example of a daily calendar used for the time management system of the present invention.

FIG. 15 is an example of the alternative menu window used for guiding the user to the appropriate area of the of the time management system of the present invention.

FIG. 16 is an example of the search engine window used for guiding the user to the appropriate area of the of the time management system of the present invention.

FIGS. 17-29 are examples of window that provide prompts for guiding the user when scheduling a particular appointment.

Similar reference numerals refer to similar reference parts throughout the several views of the drawings.

### DESCRIPTION OF THE PREFERRED EMBODIMENTS

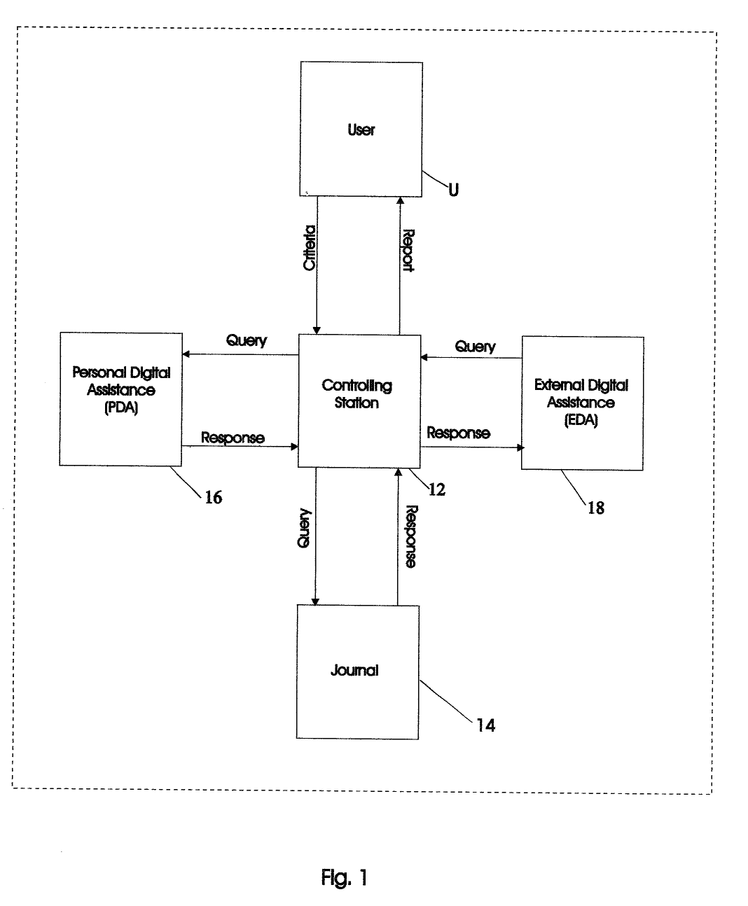

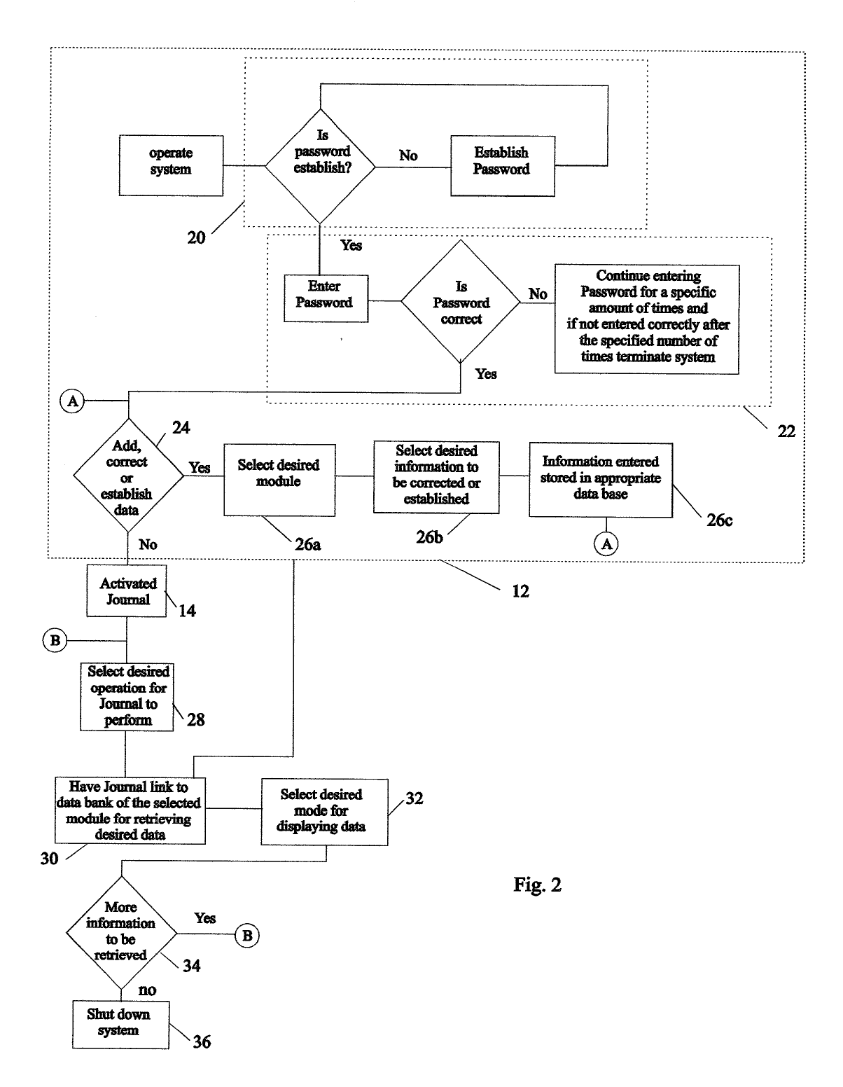

As seen in the Figures, in particular to FIGS. 1 and 2 thereof the present invention, a system providing time management capability and other related procedures, generally denoted by reference numeral 10, will be described. In essence the present invention is a time management system that is designed and configured to adequately and efficiently store pertinent data, such as appointments, schedules, meetings, and the like, and analyze and retrieve the stored data as deemed necessary by the user, so as to ultimately provide a means of altering and/or reminding the user of a particular event.

The present invention 10, as seen in FIG. 1, is a time management system that is operational on a variety of computers. The computer could be, for example, a personal computer, a mini computer or a mainframe computer. The computer can operate as a stand-alone system, as part of a Local Area Network, or as part as a Wide Area Network. For purposes of illustration only, the present invention is described below as being implemented on a personal computer. It is noted that the specific choice of computer or the like is limited only by memory and disk storage requirements.

As illustrated, the system is controlled by a user U. The user U can assess the present invention via any conventional interfacing means, such as, but not limited to personal data assistant (PDA) devices, cellular phones and the like. Thus, providing successful usability of the system 10 of the present invention can require the use of up to five separate entities. The five entities being: the user U; the controlling station 12, journal 14; the personal digital assistant (PDA) sub-station 16; and the external digital assistant (EDA) sub-station 18. The user U, of course being the operator of the present invention. Thereby providing for the present invention to comprise of four substations, known as the controlling station 12, journal 14, and personal digital assistant sub-station 16, and the external digital system sub-station 18. It is noted that to successfully operate the present invention the personal digital assistant sub-station and the external digital system sub-station need not be employed. The user can merely successfully employ the invention by-way of their personal computer.

Each sub-system or substation is a separate entity. The entities can work independently or can be coupled to one another to adequately and efficiently store, organize, update, analyze and/or execute data and/or instructions as deemed necessary by the user.

The first sub-system, known as the controlling station 12 is a computer code that is utilized for managing entered data. This station also controls and manipulates the data from and to the subsequent sub-station. The controlling station is operational on a conventional computer platform. This controlling station stores the desired data of the user. Thereby providing for this controlling station to include various data banks. The user can access this controlling station via the particular computer platform that it is stored on or can access this controlling station via the journal 14, personal digital assistant station (PDA) 16 or the external digital Assistant (EDA) station 18.

For displaying schedules or the desired information, the journal 14 is activated. This journal station 14 displays a specified primary schedule application for managing calendar events. This journal is the default scheduling application that is operated on a personal computer platform and serves as the default repository for the archival data store. Conventional programs, such as Microsoft Outlook™ or Lotus Organizer™, have been utilized to produce favorable results. However, it is to be expressly understood that the present invention could utilize other journal or default scheduling application systems.

The personal digital assistant station 16 enables conventional digital assistant devices to access the controlling station 12 of the present invention. An example of the personal digital assistant station device (EDA) includes Palm Pilot™. The external digital assistance station 18 enables conventional external digital devices to access the controlling station 12. Examples of the external digital assistant devices (PDA) include eCal™ or My Palm™.

Thus, the user U can retrieve and/or enter data into the journal via the controlling station 12, the journal 14, the personal digital assistant station 16 or the external digital assistant station 18. Having the capability of utilizing external sources for activating the present invention enhances the final product as well as increases its usability and versatility.

The controlling sub-station seen in FIG. 2, retrieves, stores, organizes and analyzes the data. In order to do so and provide for a user-friendly environment, this controlling sub-station includes the first step of establishing the program. Optionally, for added safety, the user can utilize a password 20 for activating the system of the present invention. As stated, the system can be activated utilizing a personal computer or any other available system, such as a PDA, EPA or the like, as defined above.

Once the password has been established, for all subsequent uses, the user merely enters the password for activating the present invention 22. If the password does not match after various attempts have been made, then the system is terminated 22.

After establishing the password and/or the password has been entered correctly, the user decides if any additions, establishments, corrections or alternations must be accomplished with data banks of the controlling station 24. If so, then the user selections the particular module or category of the data 26a that is to be affected. Once selected, the information is corrected and/or established 26b. The entered data is stored in the appropriate database 26c.

Each module is considered a separate module. Each module includes a separate code for categorizing, calculating and organizing the particular data. Thereby as information is requested, data is entered and it is stored to its respective data bank in its respective category or module. These categories are determined by the user and thus provide for a system that is customized to the particular user's needs and desires. Examples of the various modules include, but are not limited to professional data, family data, health data, home data, automotive data, and the like. As the data is entered, the controlling station of the present invention will be program to request additional information so as to adequately an efficiently store the pertinent information. For example when entering the information in regards to a physical examination, the present invention will require the user to enter information in regards to it being an annual exam. If so, the system of the present invention will record the data and will automatically remind the user each subsequent year to schedule their annual physical exam.

Thus, the user activates the system, selects the desired operation, which is to update/correct/add data 24, or activates journal 14. If activation occurs of the journal 14, the user selects the desire operation of the journal. The journal will link 30 with the appropriate databases of the controlling station 12 for enabling the journal to appropriately and adequately display all updated information 32 as desired by the user. The user can continue or alternatively terminate the session 34.

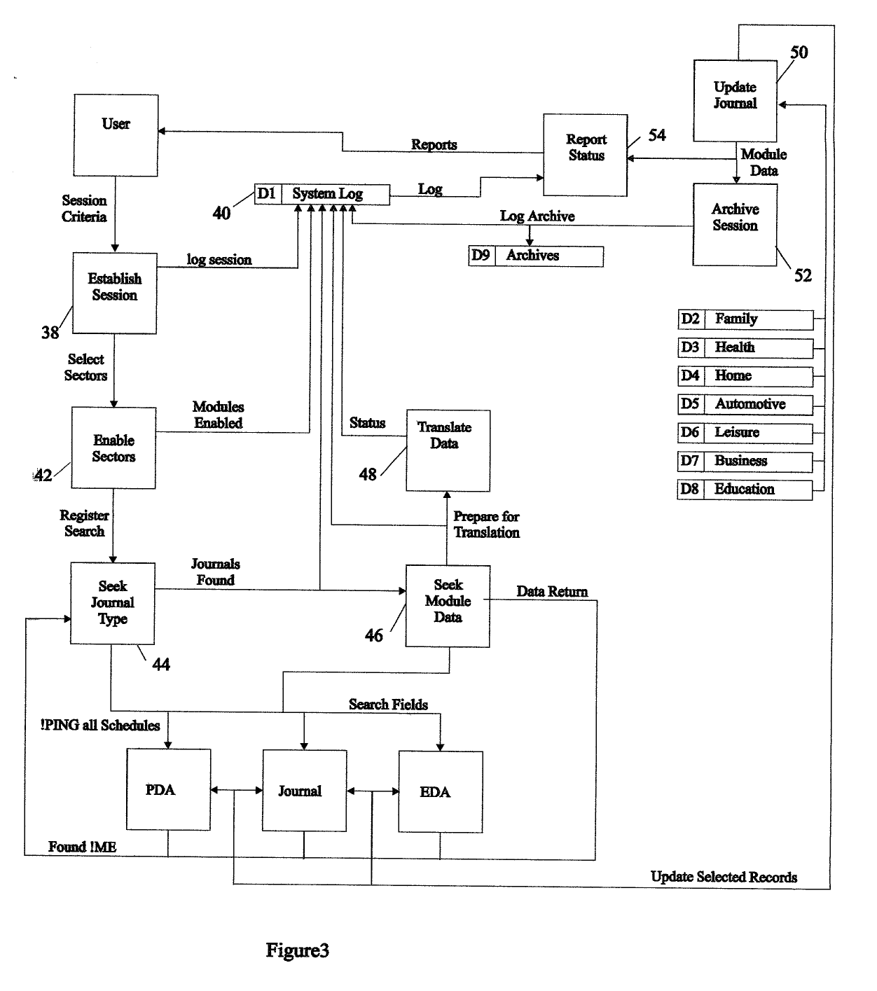

In essence, and as seen in FIG. 3, the present invention will provide for the user to establish a session 38, once the password has been entered correctly. When establishing a session 38 the user will create a session log 40, thereby either retrieving or recording data that is desired. The user will specify the delivery and/or retrieval methods, such as the use of a journal, PDA or EDA. Thereby at this point, the user will establish if he or she wishes to retrieve or submit information.

After the specification of the retrieving or recording data, the system of the present invention will enable the sectors or the particular modules 42. Thereby providing for the particular sector or module to active.

When activation has occurred the system will seek the particular journal types 44. At this point the system will search the personal computer's register for appropriate files such as *.exe, *.mdb, etc. At this station it will verify status of existing journals, log journal types found and select version for data extraction.

The module data will be sought 46. The present invention will search each journal in log for the specific module keys as desired and recommended by the user. These data keys will be returned to the module data buffers. The module buffer will be prepared for translation.

Data is translated to Universal Data Access or similar data format for rendering storage in appropriate sector data stores 48. The invention will advise the user the status of the log of translation. Thereby advising if the log was a success or failure. If failure, addition attempts can be executed.

After each use, the journals with the selected module data are updated 50. The selected module data is shared with other users and/or with other journals. The journals are balanced.

After the data has been added, updated, altered or retrieved, as indicated by the user, the selected data is archived 52. The buffers are cleared. At this point the report status can be sent by the pre-selected delivery method 54.

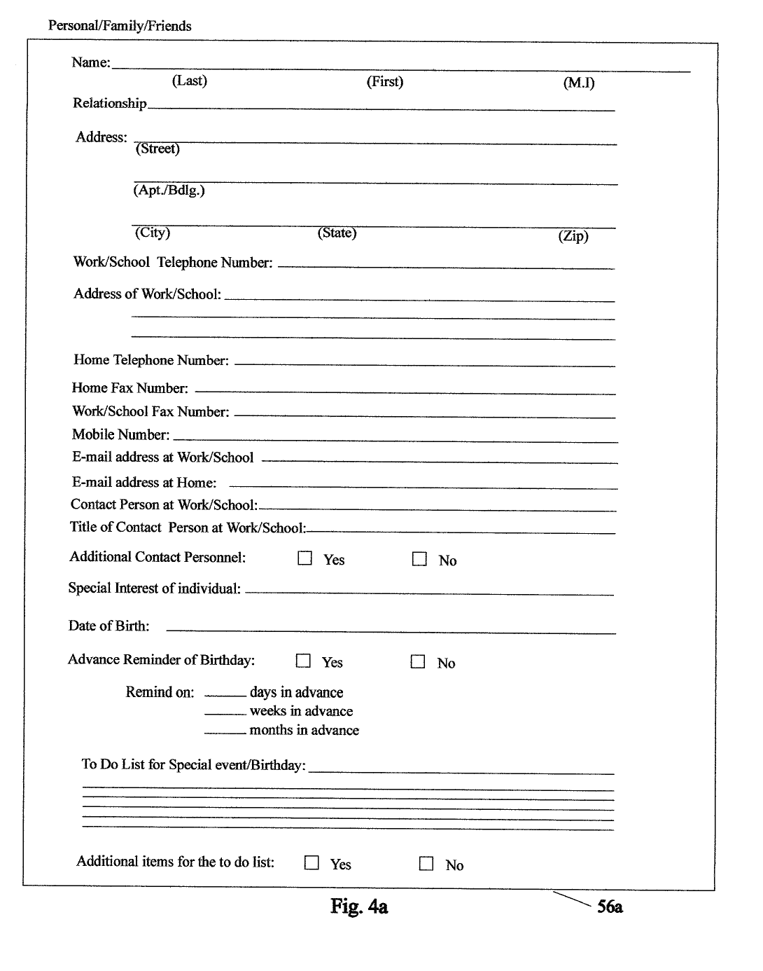

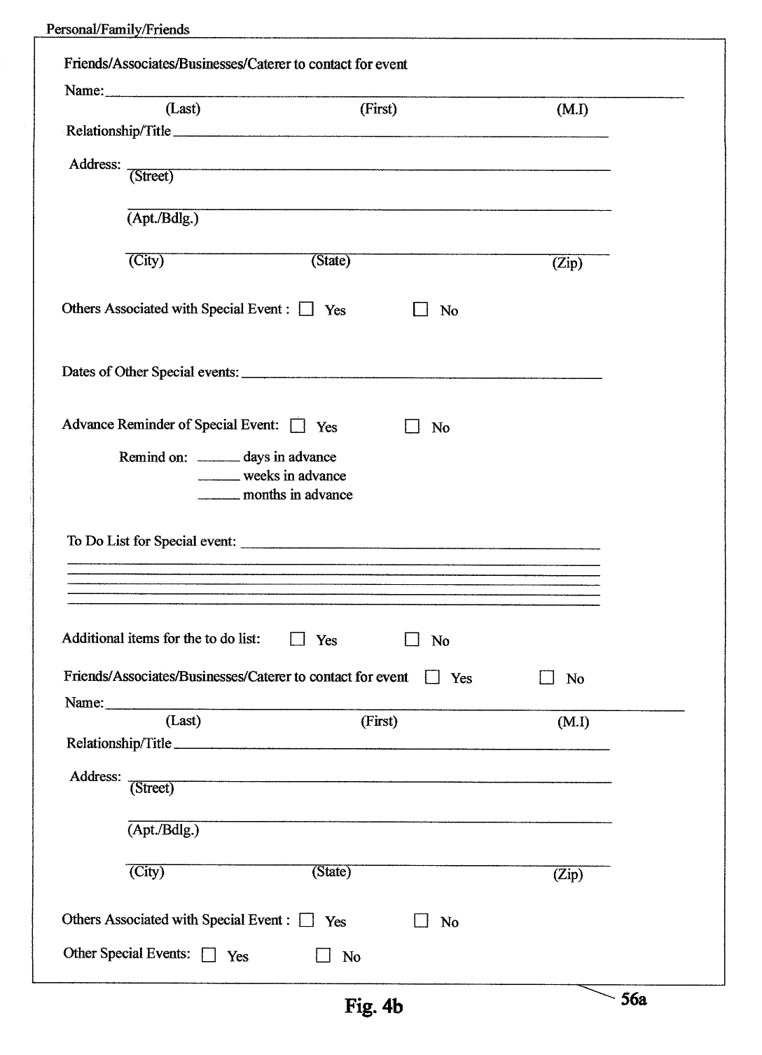

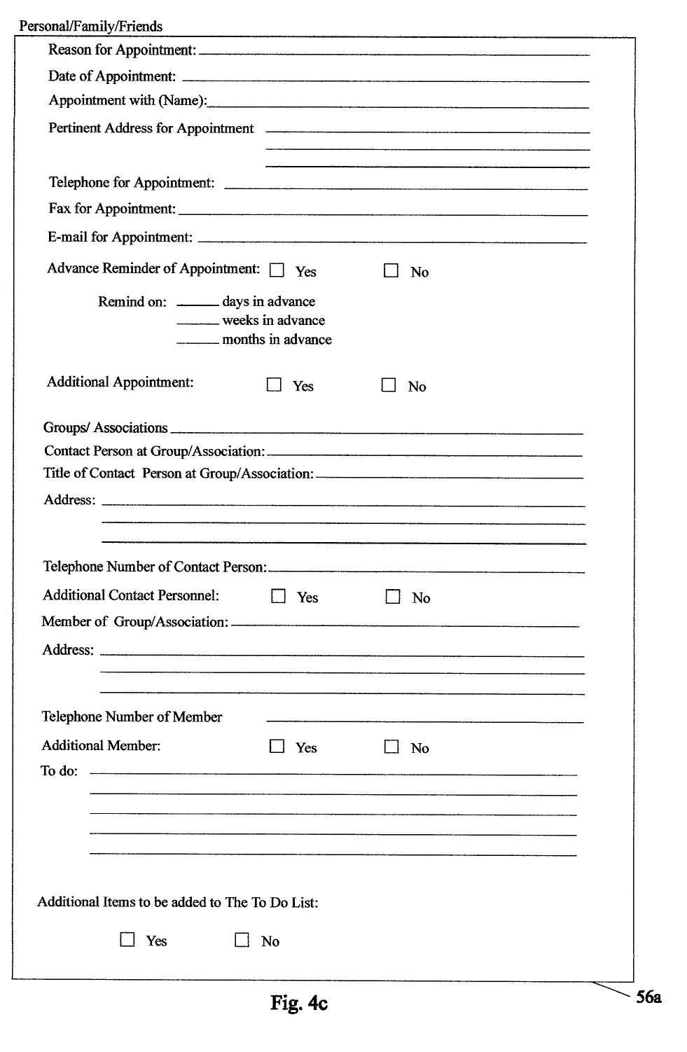

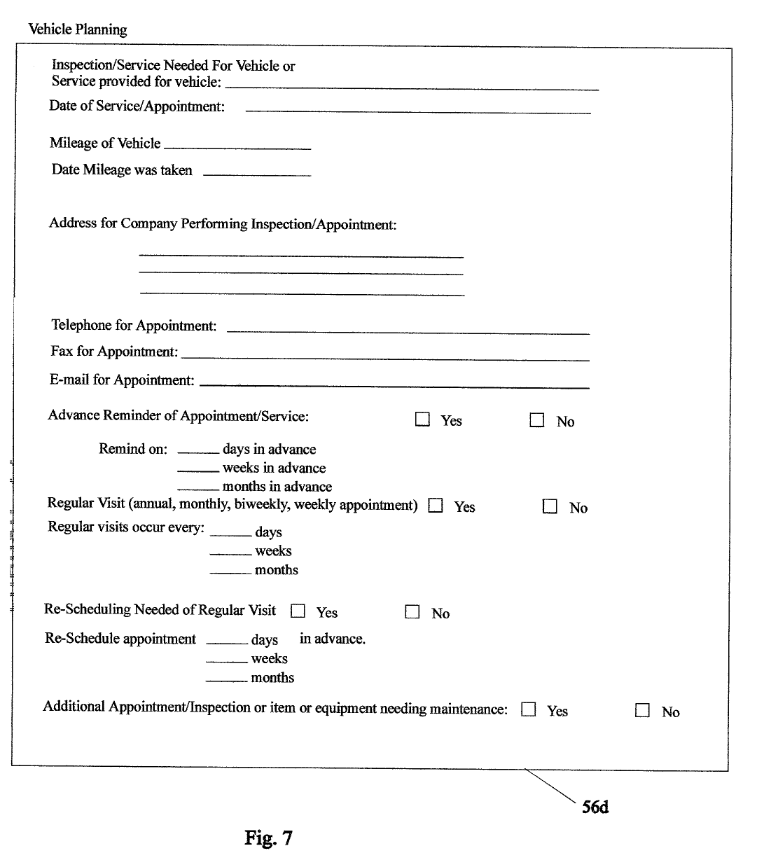

Examples of the modules and typical data that can be collected are illustrated in FIGS. 4a and 7. All modules will be equipped with advance planning capability. Thereby enabling several dates to be entered per particular event, and thus provide for a customized system. It is noted that the figures as identified above illustrate question, but it is to be understood that the questions or statements can be designed as prompts for the user.

As seen in this FIGS. 4a and 4b, various data can be collected and stored. For example, a personal, family, friend's information module can be established 56a. In this module birthdays, anniversaries, special events, addresses, phone numbers and e-mail can be stored and retrieve. The present invention is designed so that if it is a special event, i.e. a birthday the day of the special event will be recorded and stored on the user's daily calendar/daytimer. The controlling station will save this data and place this data in the Journal. Thus the user will have a record of the event when retrieving their calendar/daily schedule or the like. Advance reminders can also be recorded on at this point. For example, the user can have the special event recorded and then have the system alert the user at an advance specific time, for example, a week in advance for reminding the user of the upcoming event. The user can enter as many special events dates as desired.

The controlling station will prompt this query of questions and the answers are stored in a data bank that will be linked with the journal. Thus, when recording a particular day, the journal will record the date in their calendar so as to enable the calendar to display the correct data.

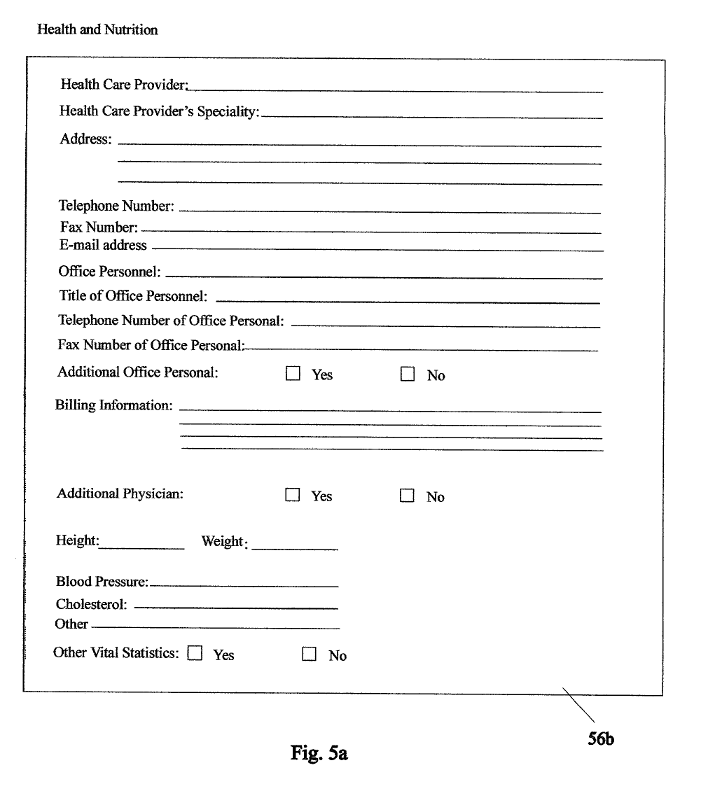

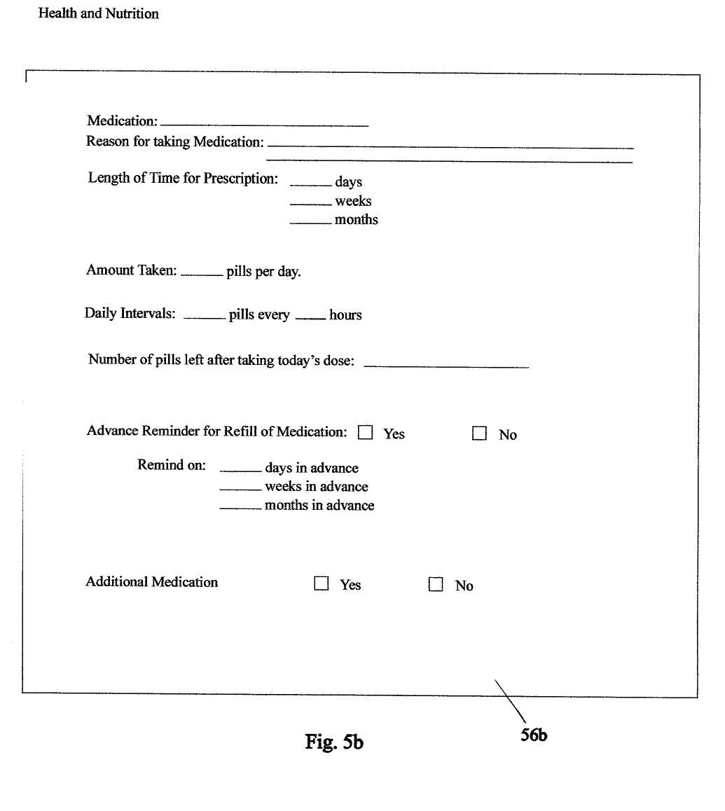

Another module would be the use of a Health and Nutrition module 56b as seen in FIGS. 5a through 5c. In this module the user can record all pertinent health information such as height, weight, age, physician, cholesterol, blood pressure and the like. Medical appointments, goals and miscellaneous reminders can be stored in this module. Advance reminders can also be recorded at this point. For example, the user can have a medical appointed recorded and then have the system alert the user at an advance specific time, for example, three months in advance, for reminding the user to schedule for an upcoming appointment.

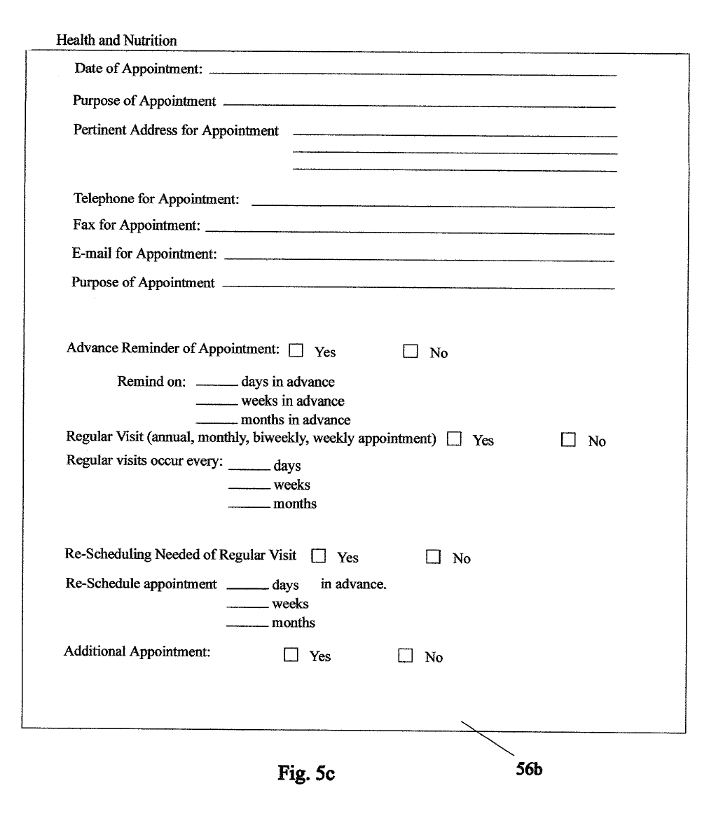

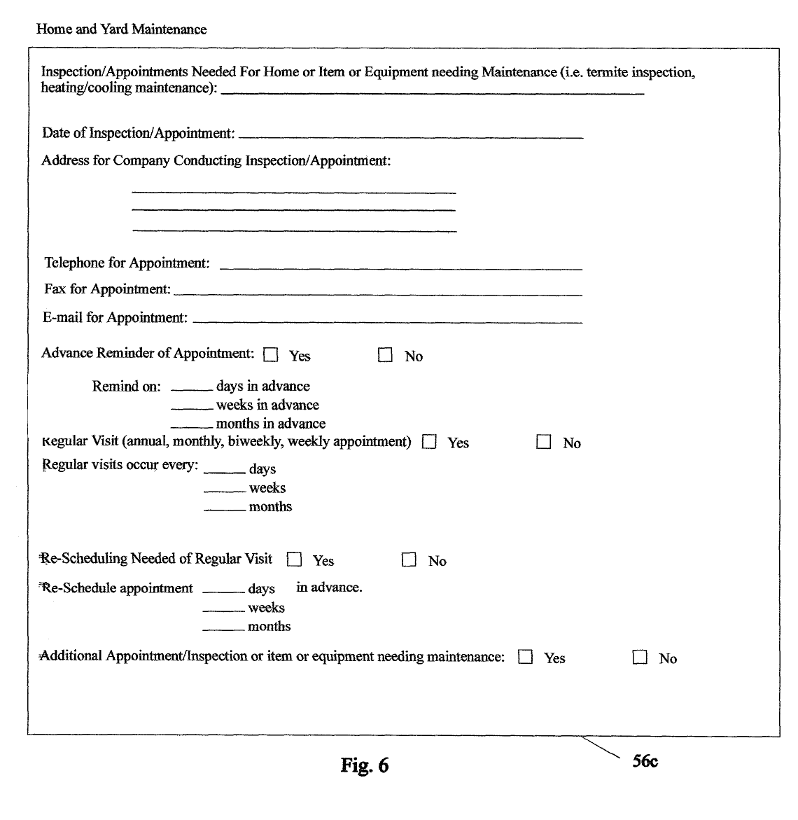

Another module can be a Home and Yard Maintenance module. With this module the user can store information in regards to inspections and services that are routinely required. Prompts and questions for retrieving information for this module are seen in FIG. 6. The information 56c one can record when to do a terminate inspection, servicing items within the home, such as a furnace, establish a date for spring cleaning, and enable the user to record a “to do” list in regards to house and home. This module will have the capability of providing advance notice of when to call for establishing an appointment or the like.

A Vehicle Maintenance module may also be beneficial. Prompts and questions for retrieving information for this module are shown in FIG. 7. With this module, with the assistance of the prompts and questions 56d, the user can record all oil changes/tune-ups, all information in regards to tires, and all information in regards to generally maintenance on each vehicle. The user can establish dates for reminding of when to service a particular vehicle. For example, every three months the user can prompt the present invention to state that an oil change is needed, or the prompt can operate via a mileage calculation, that is if the user wishes to state the appropriate mileage driven daily, weekly and/or monthly. In addition, the user can enter the mileage on a day-by-day basis.

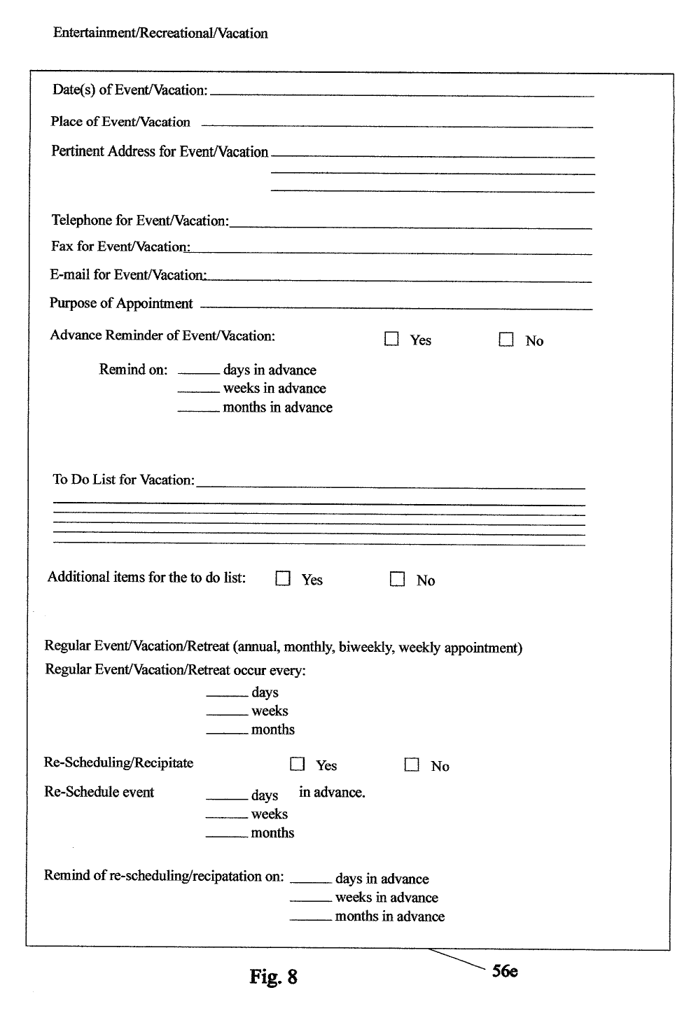

Entertainment and vacation can be yet another module. At this module, wherein an example of prompts and questions is illustrated in FIG. 8 is shown, dinners with friends can be recorded, parties can be recorded and vacation planners can be established. If the user of the present invention has been invited to dinner with friends, the system can remind the user to return the generosity by planning a dinner date with the particular friend. Thereby, the examples of the various prompts and questions 56e as seen in this figure, will aid in establishing a data bank for the entertainment and vacation module.

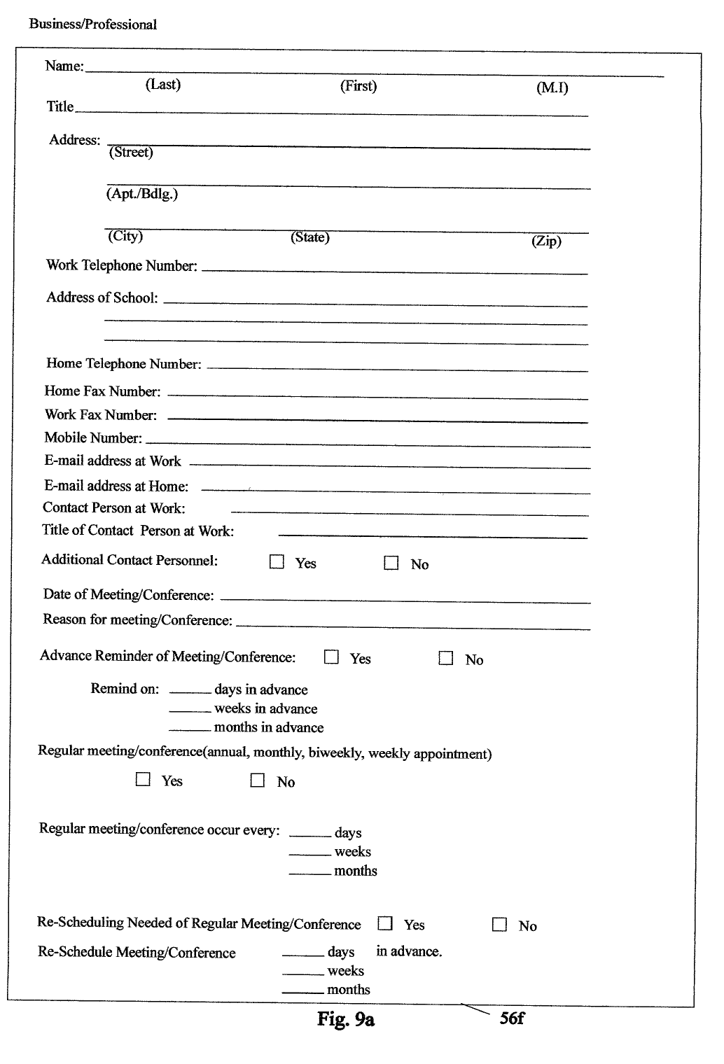

Another useful module would be the Business and Professional module. Examples of prompt and question 56f for this module is illustrated in FIG. 9. This module will record meetings, conferences, and business licensing dates and other pertinent information. For example, the module can remind the user that a class is required for a particular certification. The system can remind the user of when to schedule for the class, as determined by the user.

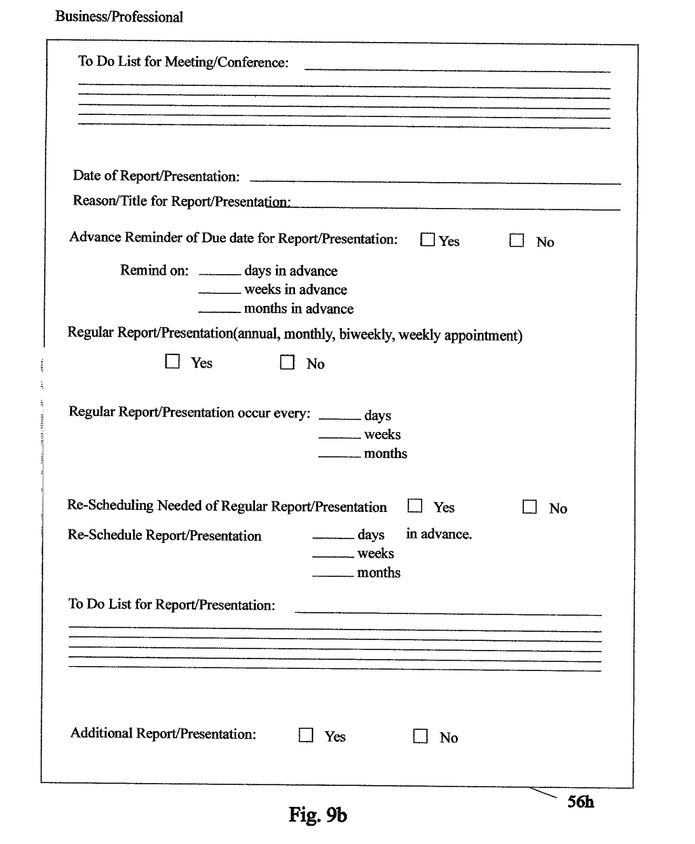

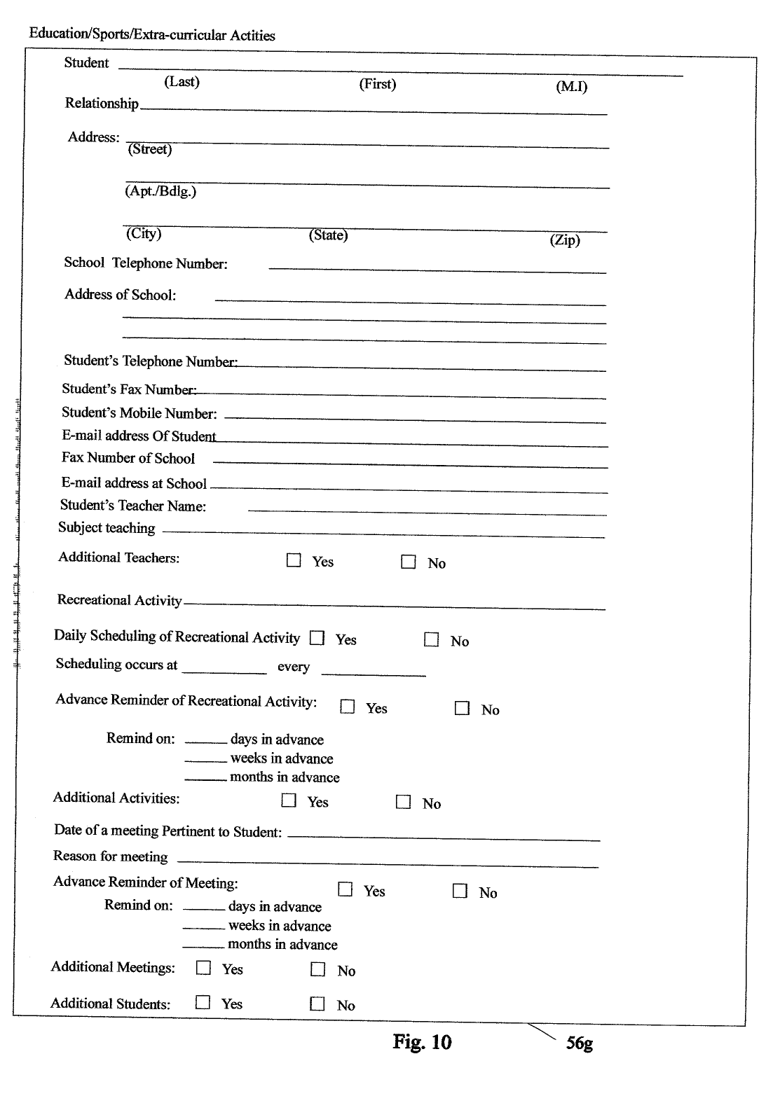

Education, sports and extra curricular activities would also be a module that may be useful and beneficial. Examples of prompt and question 56g for this module is illustrated in FIG. 10. This module the user can record the dates of special events for their children's school. For example, the user can record the day school begins/ends, all conferences with the student's teachers, and the like. In addition, this module can record all practice dates, for example, for soccer, ballet, music or the like. Recitals and game dates can also be recorded thereto.

Additional modules can be provided for further enhancing the present invention. These modules can be pre-established or optionally can be customized by the user.

For inputting the data, questions are provided for the user. These questions are answered and inputted into the present invention via any conventional means, such as the use of a keyboard, mouse, conventional scanners, data entering via the use of the Internet, or the like.

By way of example, FIG. 11-FIG. 29 illustrate examples of windows containing prompts that will aid and assist the user when utilizing the present invention. The first step, if desired, is to enter the user's identification code 60, as seen in FIG. 11. When typing the code will appear in asterisks, so as to avoid others from viewing the particular identification.

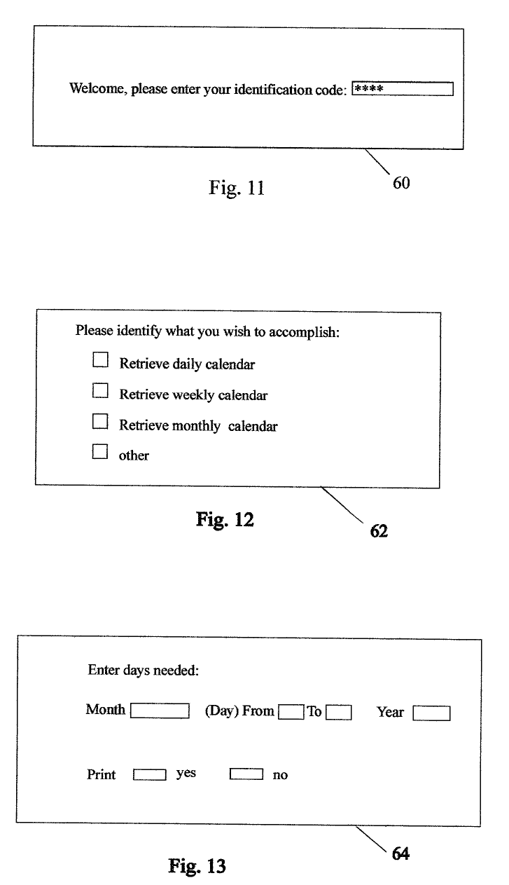

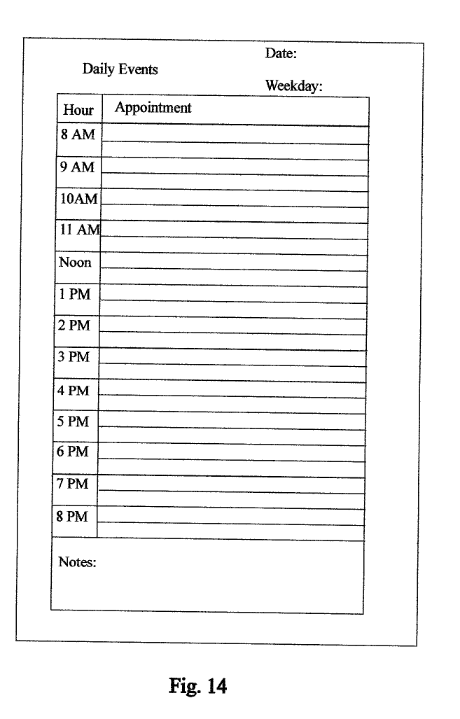

Once the code has been entered correctly, the system of the present invention is activated. This will provide for a menu window 62, as seen in FIG. 12, to be activated. This menu window will assist the user to achieve their desired goal. With this window the user can automatically retrieve a daily calendar, retrieve a weekly calendar, retrieve a monthly calendar, or other option (correcting, alternating, and changing data). If the user picks the daily calendar, then a window, as seen in FIG. 13, would appear and require the day(s) that the user wishes to see 64. This daily calendar(s) can be printed if desired. An example of a daily calendar is shown in FIG. 14. This is merely an example of what a daily calendar would look like and this is dependable upon the journal that is maintained on the user's personal computer. In this instant example, the journal would link with the existing controlling station to retrieve the pertinent data. Once retrieved, the data is transferred to the journal and illustrated on the appropriate date and mode as deemed necessary by the user.

The weekly and monthly calendar would operate in the same mode as the daily calendar and thus is not shown in separate examples. Thereby, the user would select the number of weeks/months to be displayed. Once selected, the journal would link with the controlling station for retrieving the specific data. The data would be displayed as desired by the user and according to the limitations of the journal.

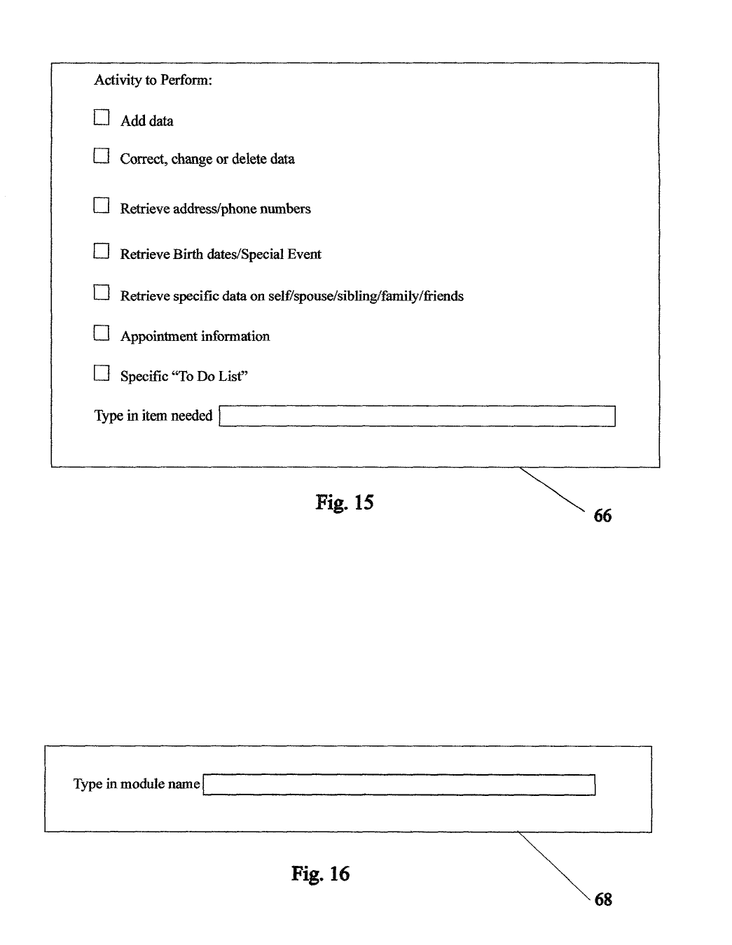

If other were selected on the first menu, then a secondary menu 66 would appear, as seen in FIG. 15. This secondary menu is designed to guide the user. As seen the user can select to add data, correct, change or delete data, retrieve address/phone numbers, retrieve birth dates/special events, retrieve specify data on a particular individual, retrieve appointment information, retrieve specific “to do” list, or optionally can utilize a search engine to indicating what they wish to accomplish.

If selecting any of the above, an optional window may appear to request the specific module 68 in which the user wishes to operate in, as seen in FIG. 16.

With each selection of the particular item listed in the secondary menu, various additional menus and prompts will appear containing questions for the modules so as to prompt and direct the user as appropriately.

By way of example, if the user selects to add data and through other prompts decides to add an appoint, then the following, as seen in FIGS. 14-29, various windows would appear to aid the user.

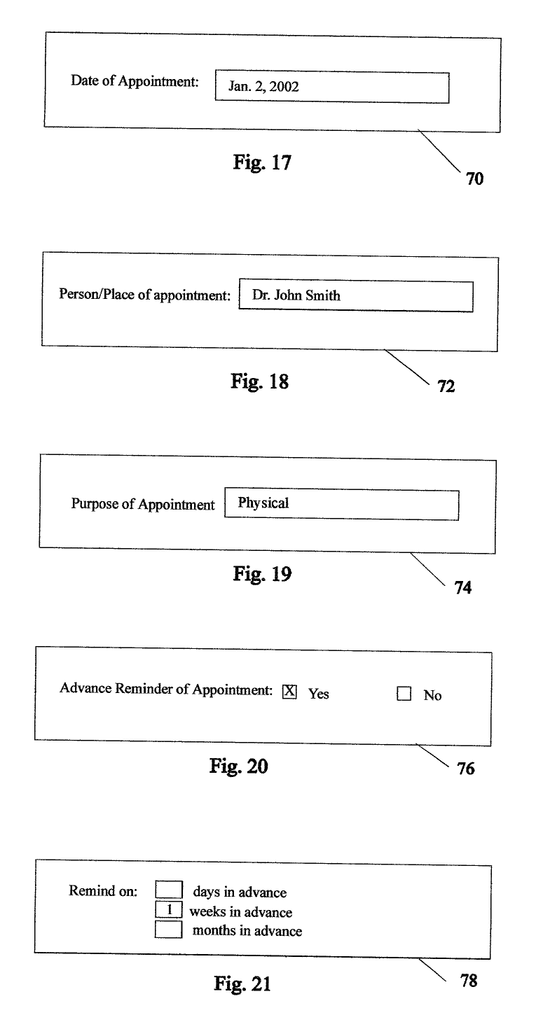

Once in the correct module, the usr would enter the date of the appointment 70 as seen FIG. 17. Once the date is located therein, it is archived in the appropriate database. Additional information is then retrieved. The controlling stating will request the place and/or person 72 with whom the appointment is with, as seen in FIG. 18. If the individual is already in the database, then the demographically information, i.e. address, phone number, need not be re-entered. The individual must state the purpose of the appointment 74, and as seen in FIG. 19, the purpose is a physical.

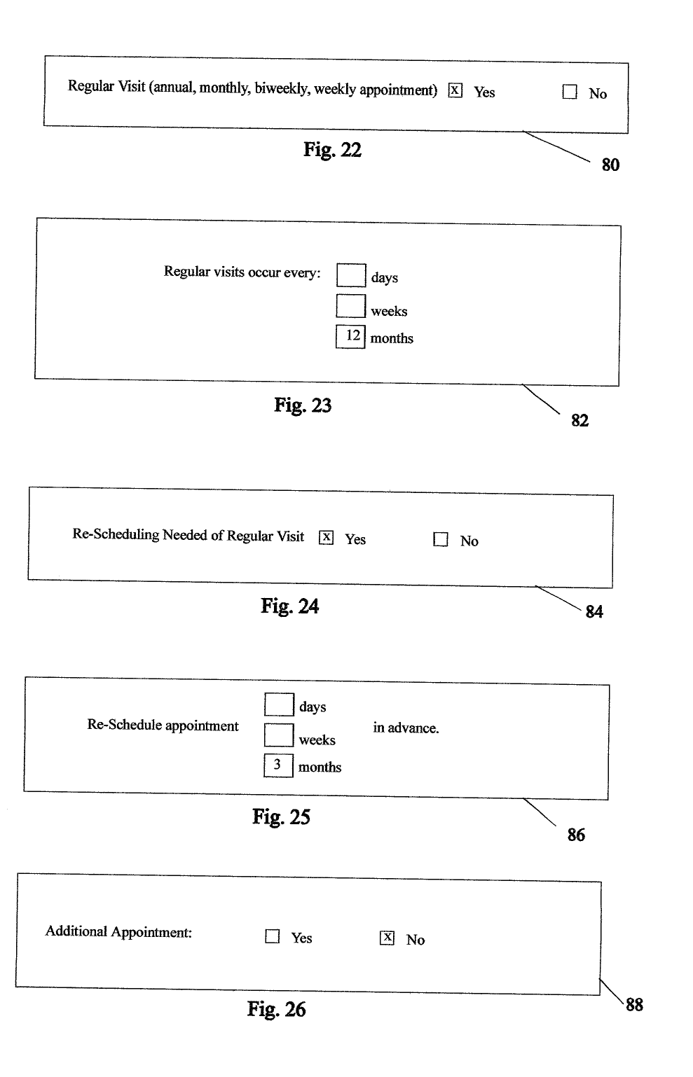

Using the system, the user can indicate if they wish to have an advance reminder of the appointment, 76 as seen in FIG. 20. If advance reminding is desired, then the user selects 78 the number of days, weeks or months prior to the particular appointment in order to be reminded, as shown in FIG. 21. To further assist the user, a window can be provided to prompt the user as to if this is a regular visit 80, FIG. 22. And if so, the user indicates when the visits occur 82, as seen in FIG. 23. With this example, the physical occurs yearly or as inputted into the database, every 12 months.

The controlling station as seen in FIG. 24 will then prompt the question of if re-scheduling is needed for this particular appointment 84. If necessary, then the controlling station, as illustrated in FIG. 25, will request how much advance notice must be given for scheduling the particular appointment 86. In this case, the user must re-schedule the appointment three months in advance. Thus the present invention will provide for an entry calculate the day for the user to call for re-scheduling the particular appointment. In this example, since the appointment is in January 2002, then the controlling station will know that re-scheduling should be done three months prior to January 2003, thus calculating that re-scheduling should be done in October 2002.

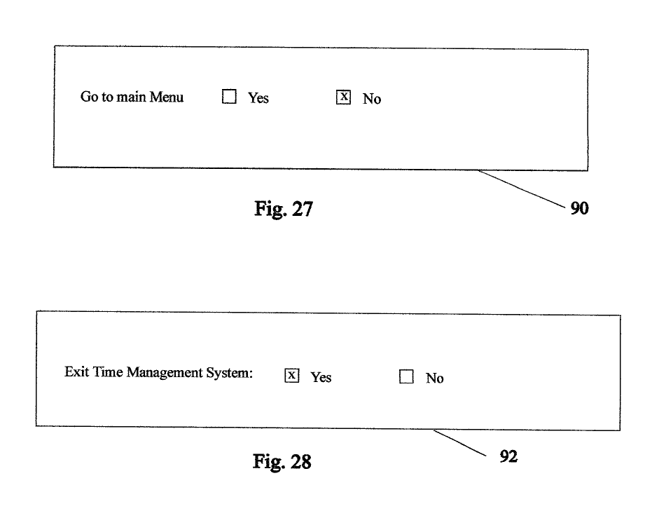

The next window that can be helpful, shown in FIG. 26, is to see if more appointments need to be entered 88, if so, the system will go to the menu illustrated in FIG. 16. If not, then the user has the option of going to the main menu 90 as seen in FIG. 27. If the user does not wish to go to the main menu then the use has the option of terminating or exiting 92 the present invention as illustrated in FIG. 28. If the user does not wish to terminate the time management system, then the present invention will return to the main menu for the user to select.

As can be seen, the present invention is designed and configured to manipulate stored data. The present invention establishes data banks and enables the user to manipulate each data bank so as to efficiently and effectively organize and enhance an existing calendar programming system, known as the journal. The present invention is user friendly and thus can be utilize with any individual who can merely turn on the computer, since the present invention will direct the individual through the process, as seen from the examples above. The present invention will prompt the user with questions so as to direct the user to the desired location and purpose for utilizing the present invention in combination with a journal or other existing software packages.

While the invention has been particularly shown and described with reference to an embodiment thereof, it will be understood by those skilled in the art that various changes in form and detail may be made without departing from the spirit and scope of the invention.

I claim:

1. A coded system for use on a computer and including a journal software package, said coded system comprising:
at least one module;
a plurality of prompts in the form of questions and an entering device for enabling a user to answer said questions;
said plurality of prompts is directed to a specific category and will aid an individual to organize entered data;
said questions provide input of needs, relationship, demographically information, preferences, strengths and pertinent information of said individual and said questions are to be answered by said individual; said at least one module is computer code and is coupled to an existing journal software package;
an entering device for entering answers from said questions into said computer and provides data for a data base and said data base is used by said computer code of said at least one module;
said at least one module interprets, processes and analyzes said data for organizing said data and links to said journal for enabling appropriate output.

2. A coded system as in claim 1 wherein at least two modules are provide and each module includes a separate set of prompts containing questions geared to a particular category, each module being a separate computer code and a user can select which module to active.

3. A coded system as in claim 1 wherein a security system is included for enabling a user to correctly input in a code for accessing said coded system and said security system and said at least one module form a controlling station.

4. A coded system as in claim 1 wherein each of said at least one module includes prompts, which will enable advance-planning capability.

5. A coded system as in claim 1 wherein each of said at least one module includes the capability of calculating a specific date for alerting a user to do a specific task prior to a specific event.
